(19) United States
(12) Patent Application Publication
(10) Pub. No.: US 2025/0373812 A1
(43) Pub. Date: Dec. 4, 2025

(54) ENCODING METHOD, DECODING METHOD AND BITSTREAM

(71) Applicant: GUANGDONG OPPO MOBILE TELECOMMUNICATIONS CORP., LTD., Dongguan (CN)

(72) Inventor: Zexing SUN, Dongguan, Guangdong (CN)

(73) Assignee: GUANGDONG OPPO MOBILE TELECOMMUNICATIONS CORP., LTD., Dongguan (CN)

(21) Appl. No.: 19/304,461

(22) Filed: Aug. 19, 2025

Related U.S. Application Data
(63) Continuation of application No. PCT/CN2023/077451, filed on Feb. 21, 2023.

(51) Int. Cl. H04N 19/14; G06T 9/00; G06T 9/20; H04N 19/169; H04N 19/70

(52) U.S. Cl. CPC H04N 19/14; G06T 9/001; G06T 9/20; H04N 19/1883; H04N 19/70

(57) ABSTRACT

The embodiments of the present application disclose an encoding/decoding method, a code stream, an encoder, a decoder, and a storage medium, the method includes: determining the bounding box volume of a current node, and determining the number of points of the current node; and when it is determined that the bounding box volume and the number of points of the current node meet a preset condition, reconstructing the current node to determine a reconstructed point cloud of the current node.

### CROSS-REFERENCE TO RELATED APPLICATION

The present application is a continuation of International Application No. PCT/CN2023/077451 filed on Feb. 21, 2023, the disclosure of which is hereby incorporated by reference in its entirety.

### BACKGROUND

At present, in point cloud encoding and decoding frameworks, including a Geometry-based Point Cloud Compression (G-PCC) encoding and decoding framework, a point cloud Audio Video Standard (AVS) encoder framework, a Low latency and Low complexity coding framework, etc., geometric information and attribute information of a point cloud are encoded separately. For encoding of the geometric information, coordinate transformation is performed on the geometric information first, such that the point cloud is included in a bounding box. Then the bounding box is the preprocessed, and the preprocessing process includes quantization and removal of duplicate points. Next, the preprocessed bounding box is encoded. For decoding of the geometric information, first decoding is performed to obtain a number of points of the current node and a size of the bounding box, and then the geometric information of the current node is decoded to reconstruct the point cloud.

The relationship between the number of points and the size of the bounding box of the current node is not defined in the above encoding and decoding processes, thus the robustness and stability of a codec may not be ensured.

### SUMMARY

Embodiments of the present disclosure relate to the technical field of point cloud data processing, in particular to an encoding method, a decoding method and a bitstream.

The embodiments of the present disclosure provide an encoding method, a decoding method and a bitstream.

The technical solution of the embodiments of the disclosure may be implemented as follows.

In a first aspect, the embodiments of the present disclosure provide a decoding method, which is applied to a decoder, and the method includes following operations.

A size of a bounding box of a current node is determined, and a number of points of the current node is determined.

When it is determined that the size of the bounding box and the number of points of the current node meet a preset condition, the current node is reconstructed to determine a reconstructed point cloud of the current node.

In a second aspect, the embodiments of the present disclosure provide an encoding method, which is applied to an encoder, and the method includes following operations.

A size of a bounding box of a current node is determined, and a number of points of the current node is determined.

When it is determined that the size of the bounding box and the number of points of the current node meet a preset condition, the current node is encoded to determine encoding information, and the encoding information is signalled in a bitstream.

In a third aspect, the embodiments of the present disclosure provide a bitstream. The bitstream is generated by bit encoding the information to be encoded. The information to be encoded includes at least one of: identification information of a first type of syntax element for indicating a volume of a bounding box of a current node, identification information of a second type of syntax element for indicating a number of points of the current node, or identification information of a third type syntax element for indicating that a current node is a node in which duplicate points are removed.

### BRIEF DESCRIPTION OF THE DRAWINGS

FIG. 1A is a schematic diagram of a three-dimensional point cloud image.

FIG. 1B is a partially enlarged schematic view of a three-dimensional point cloud image.

FIG. 2A is a schematic diagram of point cloud images at different viewing angles.

FIG. 2B is a schematic diagram of a data storage format corresponding to FIG. 2A.

FIG. 3 is a schematic diagram of a network architecture for a point cloud encoding and decoding.

FIG. 4A is a schematic block diagram of a G-PCC encoder.

FIG. 4B is a schematic block diagram of a G-PCC decoder.

FIG. 5A is a schematic diagram of vertexes of a sub-block.

FIG. 5B is a schematic diagram of fitting of a triangle soup.

FIG. 5C is a schematic diagram of upsampling of a triangle soup.

FIG. 6A is a schematic block diagram of an AVS encoder.

FIG. 6B is a schematic block diagram of an AVS decoder.

FIG. 7 is a schematic flowchart of a decoding method according to an embodiment of the present disclosure.

FIG. 8 is a schematic flowchart of an encoding method according to an embodiment of the present disclosure.

FIG. 9 is a structural schematic diagram of an encoder according to an embodiment of the present disclosure.

FIG. 10 is a structural schematic diagram of a specific hardware of an encoder according to an embodiment of the present disclosure.

FIG. 11 is a structural schematic diagram of a decoder according to an embodiment of the present disclosure.

FIG. 12 is a structural schematic diagram of a specific hardware of an encoder according to an embodiment of the present disclosure.

FIG. 13 is a structural schematic diagram of an encoding and decoding system according to an embodiment of the present disclosure.

### DETAILED DESCRIPTION

In order to enable a more detailed understanding of features and technical contents of embodiments of the present disclosure, implementation of the embodiments of the present disclosure will be described in detail below in conjunction with the accompanying drawings, which are merely provided for illustration and are not intended to limit the embodiments of the present disclosure.

Unless otherwise defined, all technical and scientific terms used herein have the same meanings as commonly understood by those skilled in the art of the present disclosure. The terms used herein are for the purpose of describing the embodiments of the disclosure only and are not intended to limit the present disclosure.

In the following description, the term “some embodiments” involved describes a subset of all possible embodiments. However, it may be understood that “some embodiments” may be the same subset or different subsets of all possible embodiments and may be combined with each other without conflict.

It is further to be pointed out that, the terms “first/second/third” involved in the embodiments of the present disclosure are merely used to distinguish similar objects, and do not represent a particular order for the objects. It is to be understood that “first/second/third” may be interchanged in a particular order or sequence when allowed, such that the embodiments of the disclosure described herein may be implemented in an order other than that illustrated or described herein.

A point cloud is a three-dimensional representation form of a surface of an object. The point cloud (data) of the surface of the object may be collected through an acquisition device such as a photoelectric radar, a lidar, a laser scanner, a multi-view camera, etc.

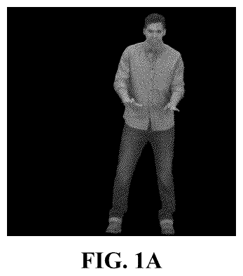

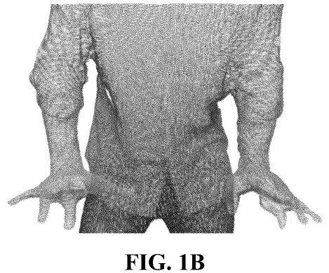

The point cloud is a set of discrete points in space which are irregularly distributed and represent a spatial structure and a surface property of a three-dimensional object or scene. FIG. 1A illustrates a three-dimensional point cloud image and FIG. 1B illustrates a partially enlarged diagram of the three-dimensional point cloud image. It can be seen that the surface of the point cloud is composed of densely distributed points.

A two-dimensional image has information expression and distribution rule at each pixel. Therefore, there is no need to record its position information additionally. However, the distribution of points in the point cloud is random and irregular in the three-dimensional space, thus it is necessary to record the position of each point in space in order to fully represent the point cloud. Similar to the two-dimensional image, each position in the collection process has corresponding attribute information, which is usually RGB colour values, and the colour values reflect the colour of the object. For the point cloud, in addition to colour information, the attribute information corresponding to each point also commonly includes a reflectance value, which reflects a surface material of the object. Therefore, a point in the point cloud may include the position information of the point and the attribute information of the point. For example, the position information of the point may be three-dimensional coordinate information (x, y, z) of the point. The position information of the point may also be referred to as geometric information of the point. For example, the attribute information of the point may include colour information (three-dimensional colour information) and/or reflectance (one-dimensional reflectance information r), and the like. For example, the colour information may be information in any kind of colour space. For example, the colour information may be RGB information. Here, R denotes Red (R), G denotes Green (G), and B denotes Blue (B). For another example, the colour information may be luminance-chrominance (YCbCr, YUV) information. Here Y denotes Luma, Cb (U) denotes blue chrominance, and Cr (V) denotes red chrominance.

For a point cloud acquired according to the laser measurement principle, a point in the point cloud may include the three-dimensional coordinate information of the point and the reflectance value of the point. For another example, for a point cloud acquired according to the photogrammetry principle, a point in the point cloud may include the three-dimensional coordinate information of the point and the three-dimensional colour information of the point. For another example, for a point cloud acquired according to the combination of the laser measurement principle and photogrammetry principle, a point in the point cloud may include three-dimensional coordinate information of the point, reflectance value of the point, and three-dimensional colour information of the point.

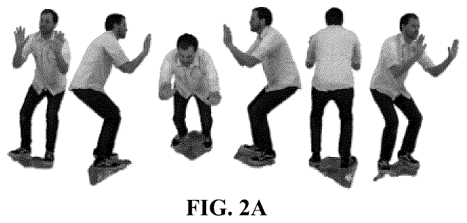

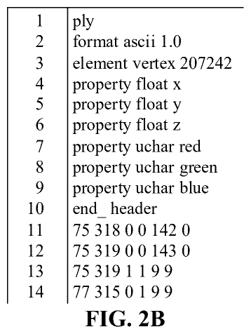

FIG. 2A and FIG. 2B illustrate a point cloud image and its corresponding data storage format. FIG. 2A provides six viewing angles for the point cloud image, and FIG. 2B is composed of a file header information part and a data part. The header information includes a data format, a data representation type, the total number of points in the point cloud, and the content represented by the point cloud. For example, the format of the point cloud is “.ply”, represented by ASCII code, the total number of points is 207242, and each point has three-dimensional coordinate information (x, y, z) and three-dimensional colour information (r, g, b).

The point clouds may be classified according to their acquisition manners as follows:
static point clouds, that is, the object is stationary, and the device that acquires the point clouds is also stationary;
dynamic point clouds, the object is in motion, but the device that acquires the point clouds is stationary;
dynamically obtained point clouds: the device that acquires the point clouds is in motion.

For example, the point clouds may be classified into two major categories according to their applications.

Category 1: Machine-perceived point clouds, which may be used in an autonomous navigation system, a real-time inspection system, a geographic information system, a visual sorting robot, an emergency rescue, the disaster relief robot and other scenarios.

Category 2: Human visually-perceived point clouds, which may be used in digital cultural heritage, free viewpoint broadcasting, three-dimensional immersive communication, three-dimensional immersive interaction, and other point cloud application scenarios.

The point cloud may flexibly and conveniently express a spatial structure and a surface property of a three-dimensional object or scene. Moreover, since the point cloud is acquired by directly sampling a real object, it can provide a strong sense of realism while ensuring the accuracy, thus the point cloud is widely used. Its scope includes the virtual reality game, the computer-aided design, the geographic information system, the automatic navigation system, the digital cultural heritage, the free viewpoint broadcasting, the three-dimensional immersive telepresentation, the three-dimensional reconstruction of biological tissues and organs, etc.

The acquisition for the point cloud mainly includes the following manners: the computer generation, the 3D laser scanning, the 3D photogrammetry, etc. The computer may generate the point cloud of the virtual three-dimensional object and scene. The 3D laser scanning may acquire the point cloud of the static real-world three-dimensional object or scene, and may acquire the million-scale point cloud per second. The 3D photogrammetry may acquire the point cloud of the dynamic real-world three-dimensional object or scene, and may obtain tens of millions scale point cloud per second. These technologies reduce the acquisition cost and time for the point cloud data, and improve the accuracy of data. The change of the acquisition manner for the point cloud data makes it possible to acquire a large amount of point cloud data. With the growth of application demand, the processing of massive 3D point cloud data encounters the challenge on the storage space and the transmission bandwidth limitation.

Exemplarily, taking a point cloud video with a frame rate of 30 frames per second (fps) as an example, the number of points of each frame of the point cloud is 700,000, and each point has coordinate information xyz (float) and colour information RGB (uchar), then the data amount of a 10 s point cloud video is about 0.7 million×(4 Byte×3+1 Byte×3)×30 fps×10 s=3.15 GB, where 1 Byte is 10 bits. However, the data amount of a 10 s 1280×720 two dimensional (2D) video with the YUV sampling format being 4:2:0 and the frame rate of 24 fps is about 1280×720×12bit×24 fps×10 s˜0.33 GB. The data amount of a 10 s two-viewpoint three dimensional (3D) video is about 0.33×2=0.66 GB. It can be seen that the data amount of the point cloud video far exceeds the data amount of the two-dimensional video and the three-dimensional video for the same duration. Therefore, in order to better implement the data management, save the server storage space, and reduce the transmission traffic and transmission time between a server and a client, the point cloud compression has become a key issue to promote the development of point cloud industry.

That is, because the point cloud is a collection of massive points, storing the point cloud not only consumes a lot of memory, but also is not conducive to transmission. Moreover, there is no such large bandwidth to support the direct transmission of the point cloud at the network layer without compression. Therefore, it is required to compress the point cloud.

At present, point cloud coding frameworks which may be used to compress the point cloud may be a Geometry-based Point Cloud Compression (G-PCC) encoding and decoding framework or a Video-based Point Cloud Compression (V-PCC) encoding and decoding framework provided by the Moving Picture Experts Group (MPEG), or an AVS-PCC encoding and decoding framework provided by the AVS. The G-PCC encoding and decoding framework may be used to compress the first type of static point cloud and the third type of dynamically obtained point cloud, which may be based on a point cloud compression test platform (Test Model Compression 13 (TMC13)). The V-PCC encoding and decoding framework may be used to compress the second type of dynamic point cloud, which may be based on a point cloud compression test platform (Test Model Compression 2 (TMC2)). Therefore, the G-PCC encoding and decoding framework is also referred to as the point cloud codec TMC13, and the V-PCC encoding and decoding framework is also referred to as the point cloud codec TMC2.

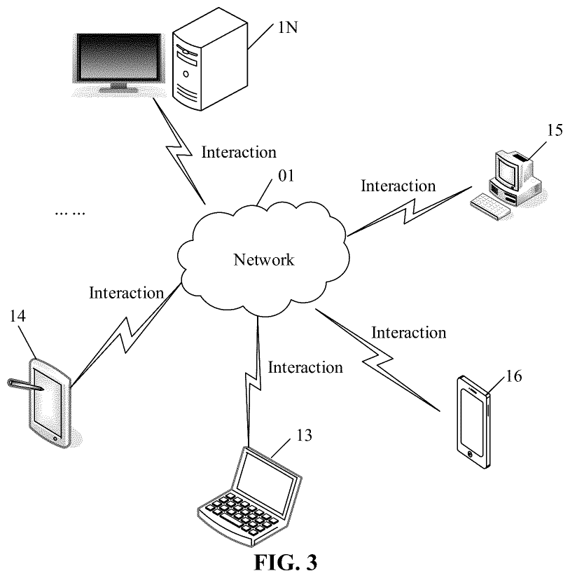

The embodiments of the present disclosure provide a network architecture for a point cloud encoding and decoding system including a decoding method and an encoding method. FIG. 3 is a schematic diagram of the network architecture for the point cloud encoding and decoding according to the embodiments of the present disclosure. As illustrated in FIG. 3, the network architecture includes one or more electronic devices 13 to 1N and a communication network 01. The electronic devices 13 to 1N may perform video interaction with each other through the communication network 01. In the process of implementation, the electronic devices may be various types of devices with point cloud encoding and decoding functions. For example, the electronic device may include a mobile phone, a tablet computer, a personal computer, a personal digital assistant, a navigator, a digital phone, a video phone, a television, a sensing device, a server, and the like, which is not limited in the embodiments of the present disclosure. The decoder or encoder in the embodiments of the present disclosure may be the electronic device as described above.

The electronic device in the embodiments of the present disclosure has the point cloud encoding and decoding function, and generally includes a point cloud encoder (i.e., an encoder) and a point cloud decoder (i.e., a decoder).

Hereinafter, the G-PCC encoding and decoding framework and the AVS encoding and decoding framework are taken as examples to explain related technologies.

It is to be understood that in the point cloud G-PCC encoding and decoding framework, point cloud data to be encoded is first divided into a plurality of slices by slice division. In each slice, geometric information of the point cloud and attribute information corresponding to each point cloud are encoded separately.

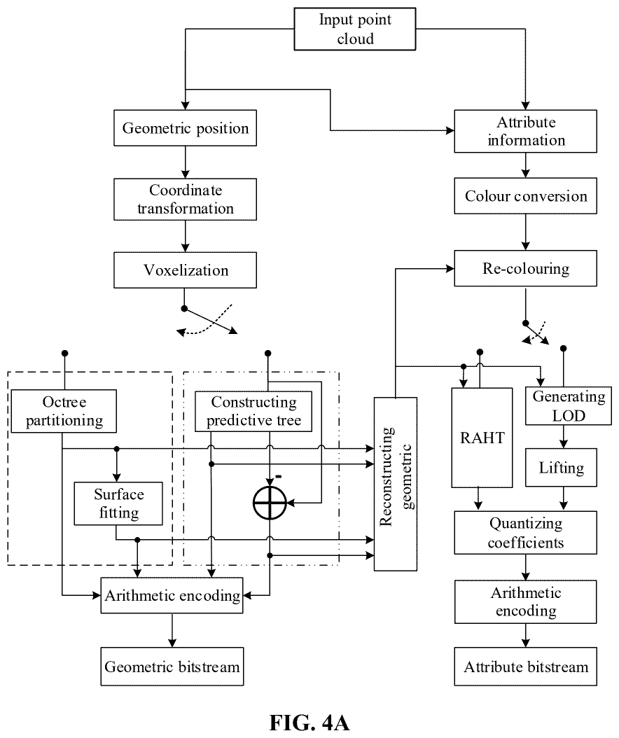

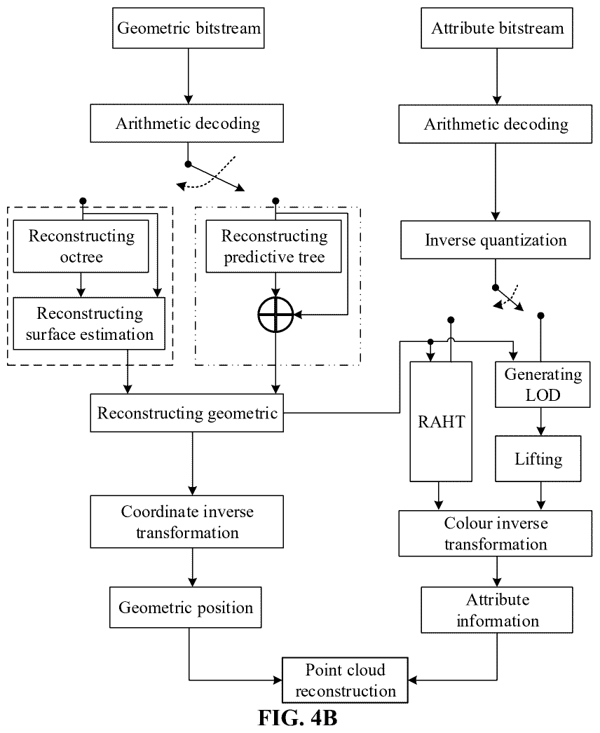

FIG. 4A illustrates a schematic block diagram of the framework of a G-PCC encoder. As illustrated in FIG. 4A, in the process of geometric encoding, the coordinate transformation is performed on the geometric information, such that all point clouds are included in a bounding box. Then the quantization is performed, and the quantization step mainly plays the role of scaling. Since the quantization is rounded, the geometric information of part of the point cloud is the same, and then it is decided whether to remove duplicate points based on the parameter. The process of quantization and removal of duplicate points is also referred to as a voxelization process. Then the octree partitioning or the predictive tree construction is performed on the bounding box. In this process, the points in the divided leaf node are arithmetically encoded to generate a binary geometric bitstream. Alternatively, the vertexes generated by the division are arithmetically encoded (surface is fitted based on the vertexes) to generate a binary geometric bitstream. In the process of attribute encoding, the geometric encoding is completed, and after the geometric information is reconstructed, it is required to perform colour transformation first, to transform the colour information (i.e., attribute information) from the RGB colour space to the YUV colour space. Then, the point cloud is re-coloured by using the reconstructed geometric information, so that the uncoded attribute information corresponds to the reconstructed geometric information. The attribute encoding is mainly performed for the colour information. In the process of encoding the colour information, there are two main transformation methods. One is the distance-based lifting transformation that relies on the division of Level of Detail (LOD). The other is to directly perform Region Adaptive Hierarchical Transform (RAHT). Both the above methods may transform the colour information from the spatial domain to the frequency domain, and the high frequency coefficient and low frequency coefficient are obtained through the transformation. The coefficients are quantized finally, and then the quantization coefficients are arithmetically encoded to generate the binary attribute bitstream.

FIG. 4B illustrates a schematic block diagram of a framework of a G-PCC decoder. As illustrated in FIG. 4B, for acquired binary bitstreams, the geometry bitstream and the attribute bitstream in the binary bitstreams are independently decoded first, respectively. When the geometric bitstream is decoded, the geometric information of the point cloud is obtained by arithmetic decoding-reconstructing the octree/reconstructing the predictive tree-reconstructing the geometric-coordinate inverse transformation. When the attribute bitstream is decoded, the attribute information of the point cloud is obtained by arithmetic decoding-inverse quantization-LOD division/RAHT-colour inverse transformation. The point cloud data to be encoded is restored based on the geometric information and the attribute information (i.e., outputting the point cloud).

It is to be noted that, as illustrated in FIG. 4A or FIG. 4B, the current geometric encoding and decoding of G-PCC may be categorized into octree-based geometric ecoding and decoding (indicated by a dashed line block) and prediction tree-based geometric encoding and decoding (indicated by a dotted line block).

For the octree geometry encoding (OctGeomEnc), the octree geometry encoding includes the following operations. The coordinate transformation is performed first on the geometric information, so that all point clouds are included in a Bounding Box. Then the quantization is performed, this quantization step mainly plays the role of scaling. Because the quantization is rounded, the geometric information of part of the points is the same, and it is decided whether to remove duplicate points based on the parameter. The process of quantization and removal of duplicate points is also referred to as the voxelization process. Next, the tree division (such as octree, quadtree, binary tree, etc.) is performed on the Bounding Box successively in the order of breadth-first traversal, and the occupancy code of each node is encoded. In the related art, a company proposed an implicit geometry partition manner. First, the bounding box (2^{d}^{ₓ}, 2^{d}^{_{y}}, 2^{d}^{_{z}}) for the point clouds is calculated, assuming that dₓ>d_{y}>d_{z}, and the bounding box corresponds to a cuboid. In the geometry division, firstly, the binary tree partitioning is continually performed based on the x-axis to obtain two child nodes until the condition dₓ=d_{y}>d_{z} is satisfied, then the quadtree partitioning is continually performed based on the x-axis and y-axis to obtain four child nodes. When the condition dₓ=d_{y}=d_{z} is met, the octree partitioning is continually performed until the leaf node obtained by the partition is a unit cube of 1×1×1. Then the points in the leaf node are encoded to generate a binary bitstream. In the process of binary tree/quadtree/octree partitioning, two parameters, K and M, are introduced. The parameter K indicates the maximum times of binary tree/quadtree partitioning before the octree partitioning is performed. The parameter M is used to indicate that the corresponding minimum block side length is 2^{M} when the binary tree/quadtree partitioning is performed. Further, K and M must meet the following condition: assuming dₘₐₓ=max(dx, dy, dz), dₘᵢₙ=min (dₓ, d_{y}, d_{z}), the parameter K meets: K≥dₘₐₓ−dₘᵢₙ, and the parameter M meets: M≥dₘᵢₙ. The reason the parameters K and M meet the above conditions is that in the current process of geometric implicit partition for the G-PCC, the priorities of the partition manners are binary tree, quadtree and octree. When the block size of the node does not meet the condition for binary tree/quadtree, the octree partitioning is continually performed on the node until it is partitioned to the minimum unit of leaf node 1×1×1. However, the octree-based geometric information coding mode only has an efficient compression rate for the points with correlation in space, while for the isolated points in geometric space, the use of Direct Coding Model (DCM) can greatly reduce the complexity. For all nodes in the octree, the use of DCM is not indicated by flag bit information, but is derived according to the parent node and neighbor information of the current node. There are two ways to determine whether the current node is eligible for DCM encoding.
(1) The current node has only one occupied child node, and the parent node of the parent node of the current node has only two occupied child nodes, that is, the current node has only one neighbor node at most.
(2) The parent node of the current node has only the current node as its occupied child node, and the six neighbor nodes that share a face with the current node are all empty nodes.

If the current node is not eligible for DCM encoding, the octree partitioning is performed on the current node. If the current node is eligible for the DCM encoding, the number of points included in the node is further determined. When the number of points is less than a threshold value (for example, 2), the node is DCM encoded; otherwise, the octree partitioning will be continued. When the DCM encoding mode is applied, the geometric coordinate (x, y, z) components of the point included in the current node will be directly encoded independently. When the side length of a node is 2^{d}, d bits are required when each component of the geometric coordinate of the node is encoded, and the bit information is directly signalled in the bitstream.

It is to be noted that when the node is partitioned into leaf nodes, in the case of geometric lossless coding, the number of duplicate points in the leaf node needs to be encoded. The occupancy information of all nodes is finally encoded to generate a binary bitstream. In addition, G-PCC currently introduces a planar coding mode. In the process of partitioning the geometry, it is determined whether the child nodes of the current node are in the same plane. If the child nodes of the current node meet the condition of the same plane, the plane will be used to represent the child nodes of the current node.

For the geometric decoding based on the octree, the decoding side continuously performs parsing in the order of breadth-first traversal to obtain the occupancy code of each node, and continuously partitions the node in turn until the unit cube of 1×1×1 is obtained. The number of points contained in each leaf node is obtained by parsing, and finally the geometric reconstructed point cloud information is obtained by recovering.

For the geometric information coding based on triangle soup (trisoup), in the geometric information coding framework based on the trisoup, the geometric partitioning should also be performed first. However, different from the geometric information coding based on the binary tree/quadtree/octree, this method does not need to partition the point cloud step by step into the unit cube with side length of 1×1×1, instead, the partitioning is stopped when the side length of a block is W. Based on the surface formed by the distribution of point cloud in each block, up to twelve vertexes generated by the surface and twelve sides of the block are obtained. The coordinates of the vertexes of each block are encoded sequentially to generate the binary bitstream.

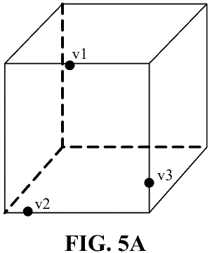

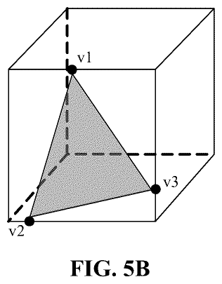

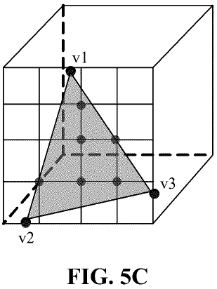

For the reconstruction of the point cloud geometric information based on trisoup, when the reconstruction for the point cloud geometric information is performed at the decoding side, the coordinates of the vertexes are first decoded to complete the trisoup reconstruction, and the process is illustrated in FIG. 5A, FIG. 5B and FIG. 5C. There are three vertexes (v1, v2, v3) in the block as illustrated in FIG. 5A, and the triangle soup formed by using these three vertexes in a certain order is referred to as the trisoup, as illustrated in FIG. 5B. Then the sampling is performed on the trisoup, and the obtained sampling points are used as the reconstructed point cloud in the block, as illustrated in FIG. 5C.

For the predictive tree-based geometry coding (predictive geometry coding, PredGeomTree), the predictive tree-based geometry coding includes that the following operations. First, the input point clouds are sorted. The sorting manners currently used include: unordered, Morton order, azimuth order and radial distance order. At the encoding side, the predictive tree structure is established in two different ways, which include: a high latency slow mode (K-Dimensional Tree, KD-Tree) and a low latency fast mode (using lidar calibration information). When the lidar calibration information is used, each point is assigned to a respective of different lasers, and the predictive tree structure is established according to different lasers. Next, based on the structure of the predictive tree, each node in the predictive tree is traversed, and the geometric position information of the node is predicted by using different prediction modes, so as to obtain the geometric prediction residual,, and the geometric prediction residual is quantized by using the quantization parameter. Finally, the prediction residual for the node position information of the predictive tree, the predictive tree structure and the quantization parameter are encoded through continuous iteration to generate the binary bitstream.

For the predictive tree-based geometric decoding, at the decoding side, the predictive tree structure is reconstructed by continuously parsing the bitstream Then the prediction residual information of the geometric position and the quantization parameter for each prediction node are obtained by parsing. The reconstructed geometric position information of each node is recovered and obtained by performing inverse quantization on the prediction residual. Finally, the geometric reconstruction is completed on the decoding side.

After the geometric coding is completed, the geometric information needs to be reconstructed. At present, the attribute coding is mainly performed for the colour information. First, the colour information is converted from the RGB colour space to the YUV colour space. Then, the point cloud is re-coloured by using the reconstructed geometric information, so that the uncoded attribute information corresponds to the reconstructed geometric information. In the colour information coding, there are two main transformation manners. One is the distance-based lifting transformation that relies on the LOD partition, and the other is the direct RAHT transformation. Both manners convert the colour information from the spatial domain to the frequency domain. The High-frequency coefficient and low-frequency coefficient are obtained through the transformation. Finally, the coefficients are quantized and encoded to generate a binary bitstream (which can be referred to as “bitstream”).

When the attribute information is predicted by using the geometric information, the Morton code may be used to search for the nearest neighbor. The Morton code corresponding to each point in the point cloud may be obtained according to the geometric coordinate of the point. The specific manner of calculating the Morton code is described as follows. For the three-dimensional coordinate with each component being represented by d-bits binary number, its three components may be expressed as:

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ} \qquad ( 1 )$$

Herein [symbol] ∈{0,1} are the binary values corresponding to the highest bit ( [symbol] =1) to the lowest bit ( [symbol] =d) of x, y, and z, respectively. The Morton code M is that [symbol] is alternately arranged in order from the highest bit to the lowest bit for x, y, z. M is calculated as follows:

$$M = {\sum }_{ℓ = 1}^{d} {2}^{3 ( d - l )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} \qquad ( 2 )$$

Herein [symbol] ∈{0,1} are the values from the highest bit (( [symbol] =1)) to the lowest bit ( [symbol] =3d) of M, respectively. After the Morton code M of each point in the point cloud is obtained, the points in the point cloud are arranged in descending order of the Morton code, and the weight value w of each point is set to 1.

It is further to be understood that for the G-PCC encoding and decoding framework, the general test condition is as follows.

(1) There are 4 kinds of test conditions.
Condition 1: The geometric position has limited loss, and the attribute is lossy.
Condition 2: The geometric position is lossless and the attribute is lossy.
Condition 3: The geometric position is lossless, and the attribute has limited loss.
Condition 4: The geometric position is lossless and the attribute is lossless.

(2) The general test sequence includes four categories: Cat1A, Cat1B, Cat3-fused, and Cat3-frame. The Cat3-frame point cloud only contains the reflectance attribute information, the Cat1A and Cat1B point clouds only contain the colour attribute information, and the Cat3-fused point cloud contains both the colour information and the reflectance attribute information.

(3) Technical routes: there are two kinds in total, which are distinguished by using the algorithm used for the geometric compression.

Technical route 1: octree coding branch.

At the encoding side, the bounding box is partitioned sequentially to obtain the sub-cubes, and the non-empty sub-cube (including the point in the point cloud) is continuously partitioned until the divided leaf node is the unit cube of 1×1×1. In the case that the geometric coding is lossless, the number of points contained in the leaf node needs to be encoded, and finally the geometric octree coding is completed to generate a binary bitstream.

At the decoding side, the decoding side continuously performs parsing in the order of breadth-first traversal to obtain the occupancy code of each node, and continuously partitions the node in order until the unit cube of 1×1×1 is obtained. In the case that the geometric decoding is lossless, it is required to perform parsing to obtain the number of points contained in each leaf node, and finally the geometric reconstructed point cloud information is recovered and obtained.

At the encoding side, the predictive tree structure is established in two different ways, which include that: a way of using the KD-Tree (high latency slow mode) and a way of using the lidar calibration information (low latency fast mode). For using lidar calibration information, each point may be assigned to a respective of different Lasers, and the predictive tree structure may be established according to different Lasers. Next, based on the structure of the predictive tree, each node in the predictive tree is traversed, and the geometric position information of the node is predicted by using different prediction modes, so as to obtain the geometric prediction residual, and the geometric prediction residual is quantized by using the quantization parameter. The prediction residual of the node information of the predictive tree, the predictive tree structure and the quantization parameter are finally encoded through continuous iteration to generate the binary bitstream.

Technical route 2: predictive tree coding branch.

At the decoding side, the predictive tree structure is reconstructed by continuously parsing the bitstream. Then, the prediction residual information of the geometric position and the quantization parameter of each prediction node are obtained by parsing. The reconstructed geometric position information of each node is recovered and obtained by performing inverse quantization on the prediction residual. Finally, the geometric reconstruction is completed on the decoding side.

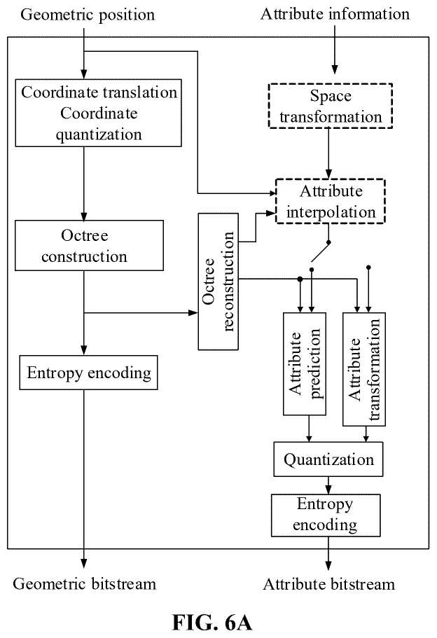

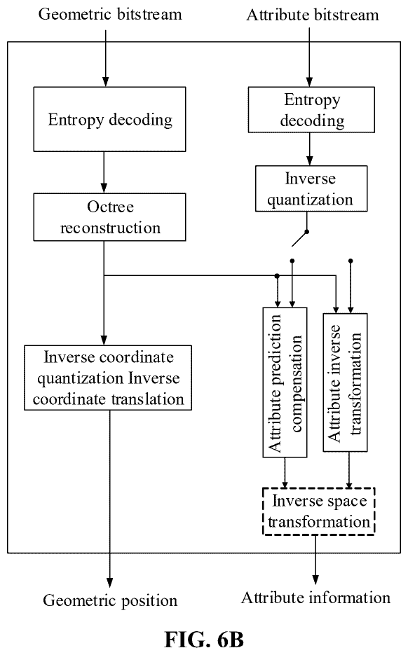

It is to be understood that in the point cloud AVS encoding and decoding framework, the geometric information of the point cloud and the attribute information corresponding to each point are also separately coded. FIG. 6A illustrates a schematic block diagram of a framework of an AVS encoder, and FIG. 6B shows a schematic block diagram of a framework of an AVS decoder.

In the framework of the AVS encoder, the coordinate transformation is performed on the geometric information first, so that all the point clouds are contained in a bounding box. Before the preprocessing process, it is determined whether to divide the entire point cloud sequence into multiple slices according to the parameter configuration. Each divided slice is processed serially as a single independent point cloud. The pre-processing process includes quantization and removing duplicate points. The quantization mainly plays the role of scaling. Because the quantization is rounded, the geometric information of part of the points is the same, and it is determined whether to remove the duplicate points based on the parameter. Next, the partition (octree/quadtree/binary tree) is performed on the bounding box in the order of breadth-first traversal, and the occupancy code of each node is encoded. In the geometric coding based on octree, the bounding box is partitioned sequentially to obtain the sub-cubes, and the non- empty sub-cube (including the point in the point cloud) is continuously partitioned until the partitioned leaf node is the unit cube of 1×1×1. Further, in the case that the geometric coding is lossless, the number of points contained in the leaf node is encoded, and finally the geometric octree coding is completed to generate a binary geometric bitstream (i.e., the geometric bitstream). In the framework of the AVS decoder, for the geometric decoding process based on the octree, at the decoding side, the occupancy code of each node is obtained by continuously performing parsing in the order of breadth-first traversal, and the node is continuously partitioned in order until the unit cube of 1×1×1 is obtained. The number of points contained in each leaf node is obtained by parsing, and finally the geometric information is recovered and obtained.

After the geometric coding is completed, the geometric information is reconstructed. At present, the attribute coding is mainly performed for the colour information and the reflectance information. First, it is determined whether or not to perform the colour space conversion. If the colour space conversion is performed, the colour information is converted from the RGB colour space to the YUV colour space. Then, the reconstructed point cloud is re-coloured by using the original point cloud, so that the uncoded attribute information corresponds to the reconstructed geometric information. The colour information coding is divided into two modules: an attribute prediction and an attribute transformation. The attribute prediction process is as follows. The point clouds are reordered first, and then the difference prediction is performed. There are two manners of reordering: Morton reordering and Hilbert reordering. The Hilbert reordering is performed for the cat1A sequence and the cat2 sequence. The Morton reordering is performed for the cat1B sequence and the cat3 sequence. Then, the attribute prediction is performed on the ordered point cloud by using the difference manner, and finally, the prediction residual is quantized and entropy coded to generate a binary attribute bitstream. The attribute transformation process is as follows. Firstly, the wavelet transformation is performed on the point cloud attribute, and the transformation coefficients are quantized. Secondly, the attribute reconstruction value is obtained by the inverse quantization and the inverse wavelet transformation. Then the difference between the original attribute and the attribute reconstructed value is calculated to obtain the attribute residual and the quantization is performed on the attribute residual. Finally, the quantized transform coefficient and the quantized attribute residual are entropy coded to generate the binary attribute bitstream (i.e. attribute bitstream). In the framework of AVS decoder, at the decoding side, entropy decoding-inverse quantization-attribute prediction compensation/attribute inverse transformation-inverse spatial transformation are performed on the attribute bitstream, and finally the attribute information is recovered and obtained.

It is further to be understood that for the AVS encoding and decoding framework, the general test condition is as follows.

(1) There are 4 kinds of test conditions.
Condition 1: The geometric position has limited loss, and the attribute is lossy.
Condition 2: The geometric position is lossless and the attribute is lossy.
Condition 3: The geometric position is lossless, and the attribute has limited loss.
Condition 4: The geometric position is lossless and the attribute is lossless.

(2) The general test sequence includes five categories: Cat1A, Cat1B, Cat1C, Cat2-frame and Cat3. Herein Cat1A and Cat2-frame point clouds only contain the reflectance attribute information, Cat1B and Cat3 point clouds only contain the colour attribute information, and Cat1C point cloud contains both the colour information and the reflectance attribute information.

(3) Technical routes: there are two kinds in total, which are distinguished by using the algorithm used for the attribute compression.

Technical route 1: prediction branch, the attribute compression uses a manner based on the intra prediction.

At the encoding side, the points in the point cloud are processed in a certain order (original acquisition order of the point cloud, Morton order, Hilbert order, etc.). First, the prediction algorithm is used to obtain the attribute prediction value, and the attribute residual is obtained according to the attribute value and the attribute prediction value. Then the attribute residual is quantized to generate the quantization residual, and finally the quantization residual is encoded.

At the decoding side, the points in the point cloud are processed according to a certain order (original acquisition order of the point cloud, Morton order, Hilbert order, etc.). First, the prediction algorithm is used to obtain the attribute prediction value, and then the quantization residual is obtained by decoding. Then the quantization residual is inversely quantized. Finally, the attribute reconstruction value is obtained according to the attribute prediction value and the inversely quantized residual.

Technical route 2: prediction transform branch-resources are limited. The attribute compression uses a manner based on the intra prediction and Discrete Cosine Transform (DCT). When the quantized transform coefficient is coded, there is a limitation for the maximum number of points X (such as 4096), that is, at most every X point is encoded as a group.

At the encoding side, the points in the point cloud are processed according to a certain order (original acquisition order of point cloud, Morton order, Hilbert order, etc.). The entire point cloud is first divided into a plurality of small groups with the maximum length Y (such as 2), and then the plurality of small groups are combined into a plurality of large groups (the number of points in each large group does not exceed X, such as 4096). Then, the attribute prediction value is obtained by using the prediction algorithm, and the attribute residual is obtained according to the attribute value and attribute prediction value. The DCT is performed on the attribute residual in unit of a small group to generate the transformation coefficient. Then the transformation coefficient is quantized to generate the quantized transformation coefficient. The quantized transformation coefficient is encoded finally in unit of a large group.

At the decoding side, the points in the point cloud are processed according to a certain order (original acquisition order of point cloud, Morton order, Hilbert order, etc.). The entire point cloud is first divided into a plurality of small groups with the maximum length Y (such as 2), and then the plurality of small groups are combined into a plurality of large groups (the number of points in each large group does not exceed X, such as 4096). The quantized transform coefficient is obtained by decoding in unit of a large group, and then the attribute prediction value is obtained by using the prediction algorithm. Then the quantized transform coefficient is inversely quantized and inversely transformed in unit of a small group, and the attribute reconstruction value is finally obtained according to the attribute prediction value and the inversely quantized and inversely transformed coefficient.

Technical route 3: prediction transform branch-resources are not limited. The attribute compression uses a manner based on the intra prediction and the DCT. When the quantized transform coefficient is encoded, there is no limitation for the maximum number of points X, that is, all coefficients are encoded together.

At the encoding side, the points in the point cloud are processed according to a certain order (original acquisition order of point cloud, Morton order, Hilbert order, etc.). First, the entire point cloud is divided into a plurality of small groups with the maximum length Y (such as 2), then the attribute prediction value is obtained by using the prediction algorithm, and the attribute residual is obtained according to the attribute value and attribute prediction value. The DCT is performed on the attribute residual in unit of a small group to generate the transform coefficient, then the transformation coefficient is quantized to generate the quantized transform coefficient. The quantized transform coefficient for the entire point cloud is encoded finally.

At the decoding side, the points in the point cloud are processed according to a certain order (original acquisition order of point cloud, Morton order, Hilbert order, etc.). The whole point cloud is first divided into a plurality of small groups with the maximum length Y (such as 2). The quantized transform coefficient for the entire point cloud is obtained by decoding, and then the attribute prediction value is obtained by using the prediction algorithm. Then the quantized transform coefficient is inversely quantized and inversely transformed in unit of a small group, and the attribute reconstruction value is finally obtained according to the attribute prediction value and the inversely quantized and inversely transformed coefficient.

Technical route 4: Multi-layer transform branch. The attribute compression uses a manner based on the multi-layer wavelet transform.

At the encoding side, the multi-layer wavelet transform is performed on the entire point cloud to generate the transform coefficient, then the transform coefficient is quantized to generate the quantized transform coefficient, and the quantized transform coefficient for the entire point cloud is finally encoded.

At the decoding side, the quantized transform coefficient for the entire point cloud is obtained by decoding, and then the quantized transform coefficient is inversely quantized and inversely transformed to obtain the attribute reconstruction value.

The embodiments of the present disclosure provide an encoding and decoding method. When geometric information of a point cloud is encoded/decoded, a relationship between a number of points and a volume of a bounding box is defined according to a relationship between a number of points and a volume of a bounding box of a reconstructed point cloud of the current node, thus the robustness and stability of the codec can be ensured without affecting the encoding and decoding efficiency.

The embodiments of the present disclosure will be described in detail below with reference to the accompanying drawings.

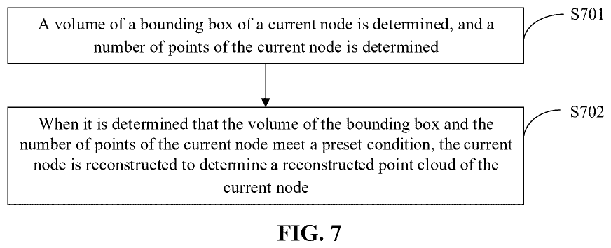

In an embodiment of the present disclosure, referring to FIG. 7, FIG. 7 illustrates a schematic flowchart of a decoding method provided by the embodiment of the present disclosure. As illustrated in FIG. 7, the method may include operations S701 to S702.

At S701, a volume of a bounding box of a current node is determined, and a number of points of the current node is determined.

In some embodiments, the current node is a node, in which the duplicate points are removed, in the point cloud. Exemplarily, the current node includes at least one of: a current point cloud sequence, a current point cloud frame, a current point cloud tile, or a current point cloud slice.

In some embodiments, when the current node is a point cloud tile, it is determined that the entire point cloud sequence is divided into a plurality of point cloud tiles according to a parameter configuration, and each point cloud tile is processed as a single independent point cloud.

In some embodiments, when the current node is a point cloud slice, it is determined that the entire point cloud sequence is divided into a plurality of point cloud slices according to a parameter configuration, and each point cloud slice is processed as a single independent point cloud.

In some embodiments, the operation that the bounding box volume of the current node is determined includes that: a bitstream is decoded to determine identification information of a first type of syntax element for the current node; and a volume of the bounding box of the current node is determined according to the identification information of the first type of syntax element. The identification information of the first type of syntax element may be understood as a set including identification information of one or more syntax elements.

It is to be noted that the first type of syntax element may be a high-level syntax element for the current node, which is used to indicate the bounding box volume of the current node. The first type of syntax element includes at least one of: a sequence-level syntax element, a frame-level syntax element, a tile-level syntax element, and a slice-level syntax element. In some embodiments, when the current node is a point cloud slice, the first type of syntax element is a slice-level syntax element, and may be located in a slice header. When the current node is a point cloud tile, the first type of syntax element is a tile-level syntax element, and may be located in a tile header. When the current node is a point cloud frame, the first type of syntax element is a frame-level syntax element, and may be located in a frame header. When the current node is a point cloud sequence, the first type of syntax element is a sequence-level syntax element, and may be located in a sequence header.

It is to be noted that the identification information of the first type of syntax element is used to directly indicate the volume of the bounding box, or the first type of syntax element is used to indicate a length, width and height of the bounding box of the current node, and the volume of the bounding box is further obtained according to the product of the length, width and height of the bounding box.

Exemplarily, the first type of syntax element includes: identification information of a first syntax element, identification information of a second syntax element, and identification information of a third syntax element. The identification information of the first syntax element is used to indicate the length of the bounding box, the identification information of the second syntax element is used to indicate the width of the bounding box, and the identification information of the third syntax element is used to indicate the height of the bounding box.

The operation that a bounding box volume of a current node is determined according to the identification information of the first type of syntax element includes operations that: the length of the bounding box is determined according to the identification information of the first syntax element; the width of the bounding box is determined according to the identification information of the second syntax element; the height of the bounding box is determined according to the identification information of the third syntax element; and the volume of the bounding box of the current node is determined by calculating a product of the length, the width, and the height of the bounding box of the current node.

In some embodiments, the identification information of the first syntax element includes identification information of at least two sub-syntax elements, the identification information of the second syntax element includes identification information of at least two sub-syntax elements, and the identification information of the third syntax element includes identification information of at least two sub-syntax elements.

It is to be noted that the size of the bounding box may be indicated by two or more sub-syntax elements, and each sub-syntax element is used to indicate the values at partial positions of the size of the bounding box. For example, the identification information of the at least two sub-syntax elements includes identification information of a first sub-syntax element and identification information of a second sub-syntax element. The identification information of the first sub-syntax element is used for indicating values of lower bits of the size of the bounding box, and the identification information of the second sub-syntax element is used for indicating values of higher bits of the size of the bounding box.

Exemplarily, taking the current node being a point cloud slice as an example, and the identification information of the first type of syntax element includes followings.

A higher part of bits of a logarithmic size of a slice bounding box in X-direction, which is referred to as gsh_bounding_box_nodeSizeXLog2_upper, is an unsigned integer and represents bits higher than the 16-th bit of the logarithmic size of the slice bounding box in X-direction.

A lower part of the bits of the logarithmic size of the slice bounding box in X-direction, which is referred to as gsh_bounding_box_nodeSizeXLog2_lower, which is an unsigned integer and represents lower 16 bits of the logarithmic size of the slice bounding box in X-direction.

The logarithmic size of the slice bounding box in X direction is:

gsh_bounding_box_nodeSizeXLog2=(gsh_bounding_box_nodeSizeXLog2_upper)<<16+
gsh_bounding_box_nodeSizeXLog2_lower

A higher part of bits of a logarithmic size of the slice bounding box in Y-direction, which is referred to as gsh_bounding_box_nodeSizeYLog2_upper, is an unsigned integer and represents bits higher than the 16-th bit of the logarithmic size of the slice bounding box in Y-direction.

A lower part of the bits of the logarithmic size of the slice bounding box in Y-direction, which is referred to as gsh_bounding_box_nodeSizeYLog2_lower, is an unsigned integer and represents lower 16 bits of the logarithmic size of the slice bounding box in Y-direction.

The logarithmic size of the slice bounding box in Y direction is:

gsh_bounding_box_nodeSizeYLog2=(gsh_bounding_box_nodeSizeYLog2_upper)<<16+
gsh_bounding_box_nodeSizeYLog2_lower

A higher part of bits of a logarithmic size of the slice bounding box in Z-direction, which is referred to as gsh_bounding_box_nodeSizeZLog2_upper, is an unsigned integer and represents bits higher than the 16-th bit of the logarithmic size of the slice bounding box in Z-direction.

A lower part of the bits of the logarithmic size of the slice bounding box in Z-direction, which is referred to as gsh_bounding_box_nodeSizeZLog2_lower, is an unsigned integer and represents lower 16 bits of the logarithmic size of the slice bounding box in Z-direction.

The logarithmic size of the slice bounding box in Z direction is:

gsh_bounding_box_nodeSizeZLog2=(gsh_bounding_box_nodeSizeZLog2_upper)<<16+
gsh_bounding_box_nodeSizeZLog2_lower

In some embodiments, the operation that the number of points of the current node is determined includes that: a bitstream is decoded to determine identification information of a second type of syntax element for the current node; and a number of points of the current node is determined according to the identification information of the second type of syntax element. The identification information of the second type of syntax element may be understood as a set including identification information of one or more syntax elements.

It is to be noted that the second type of syntax element may be a high-level syntax element for the current node, and is used to indicate a number of point cloud reconstruction points of the current node. The second type of syntax element includes at least one of: a sequence-level syntax element, a frame-level syntax element, a tile-level syntax element, or a slice-level syntax element. In some embodiments, when the current node is a point cloud slice, the second type of syntax element is a slice-level syntax element, and may be located in a slice header. When the current node is a point cloud tile, the second type of syntax element is a tile-level syntax element, and may be located in a tile header. When the current node is a point cloud frame, the second type of syntax element is a frame-level syntax element, and may be located in a frame header. When the current node is a point cloud sequence, the second type of syntax element is a sequence-level syntax element, and may be located in a sequence header.

In some embodiments, the identification information of the second type of syntax element includes identification information of at least two sub-syntax elements.

It is to be noted that the number of points may be indicated by two or more sub-syntax elements, and each sub-syntax element is used to indicate values of partial positions of the number of points. For example, the identification information of the at least two sub-syntax elements includes identification information of a third sub-syntax element and identification information of a fourth sub-syntax element. The identification information of the third sub-syntax element is used for indicating values of lower bits of the number of points, and the identification information of the fourth sub-syntax element is used for indicating values of higher bits of the number of points.

Exemplarily, taking the current node being a point cloud slice as an example, and the identification information of the second type of syntax element includes followings.

A higher part of bits of a number of points contained in a slice, which is referred to as num_points_upper, is an unsigned integer and represents bits higher than the 16-th bit in the number of points contained in the slice.

A lower part of the bits of the number of points contained in the slice, which is referred to as num_points_lower, is an unsigned integer and represents the lower 16 bits of the number of points contained in the slice.

The number of points contained in the slice is: num_points =((num_points_upper<<16)+num_points_lower).

The relationship between the number of points num_points and gsh_bounding_box_nodeSizeXLog2, gsh_bounding_box_nodeSize YLog2, and gsh_bounding_box_nodeSizeZLog2 is defined as following: num_points<=(gsh_bounding_box_nodeSizeXLog2xgsh_bounding_box_nodeSizeYLog2x gsh_bounding_box_nodeSizeZLog2)

Exemplarily, the embodiments of the present disclosure define the relationship between the number of points in the point cloud slice and the volume of the bounding box to ensure the stability of the codec. The specific definition of the geometric slice header is shown in Table 1.

TABLE 1
Definition of the geometry slice header

| | Descriptor |
|---|---|
| Geometry_slice_header( ) { | |
| slice_id | ue(v) |
| gsh_context_mode | u(1) |
| if(gps_single_mode_flag) | |
| gsh_single_mode_flag | u(1) |
| gsh_bounding_box_offset_x_upper | u(16) |
| marker_bit | f(1) |
| gsh_bounding_box_offset_x_lower | u(16) |
| marker_bit | f(1) |
| gsh_bounding_box_offset_y_upper | u(16) |
| marker_bit | f(1) |
| gsh_bounding_box_offset_y_lower | u(16) |
| marker_bit | f(1) |
| gsh_bounding_box_offset_z_upper | u(16) |
| marker_bit | f(1) |
| gsh_bounding_box_offset_z_lower | u(16) |
| marker_bit | f(1) |
| gsh_bounding_box_nodeSizeXLog2_upper | ue(v) |
| marker_bit | f(1) |
| gsh_bounding_box_nodeSizeXLog2_lower | ue(v) |
| marker_bit | f(1) |
| gsh_bounding_box_nodeSizeYLog2_upper | ue(v) |
| marker_bit | f(1) |
| gsh_bounding_box_nodeSizeYLog2_lower | ue(v) |
| marker_bit | f(1) |
| gsh_bounding_box_nodeSizeZLog2_upper | ue(v) |
| marker_bit | f(1) |
| gsh_bounding_box_nodeSizeZLog2_lower | ue(v) |
| marker_bit | f(1) |
| num_points_upper | ue(v) |
| marker_bit | f(1) |
| num_points_lower | ue(v) |
| marker_bit | f(1) |
| byte_alignment( ) | |
| } | |

It is to be noted that the naming of the syntax elements in the embodiments of the present disclosure is mainly for convenience of understanding and description, and some modifications may be made in actual applications and the standard specifications, but the semantic contents thereof should be consistent or similar.

The current node is a node in which the duplicate points are removed. In some embodiments, the bitstream is decoded to determine identification information of a third type of syntax element for the current node, and it is determined that the current node is a node in which duplicate points are removed according to the identification information of the third type of syntax element. The identification information of the third type of syntax element may be understood as a set including identification information of one or more syntax elements.

The third type of syntax element may be a high-level syntax element for the current node, and is used to indicate whether there are duplicate points in the current node. The third type of syntax element includes at least one of: a sequence-level syntax element, a frame-level syntax element, a tile-level syntax element, or a slice-level syntax element. In some embodiments, the third type of syntax element is a sequence-level syntax element, and is used to indicate that there are no duplicate points in the point cloud sequence in which the current node is located. In some embodiments, the third type of syntax element is frame level syntax element, and is used to indicate that there are no duplicate points in the point cloud frame in which the current node is located. In some embodiments, the third type of syntax element is a tile level syntax element, and is used to indicate that there are no duplicate points in the point cloud tile in which the current node is located. In some embodiments, the third type of syntax element is a slice level syntax element, and is used to indicate that there are no duplicate points in the current point cloud slice.

In some embodiments, when a value of the identification information of the third type of syntax element is a first preset value, it is determined that the current node is a node in which the duplicate points are removed. The volume of the bounding box of the current node is determined according to the identification information of the first type of syntax element. The number of points of the current node is determined according to the identification information of the second type of syntax element. When it is determined that the volume of the bounding box and the number of points of the current node meet a preset condition, the current node is reconstructed to determine a reconstructed point cloud of the current node. In some embodiments, when the value of the identification information of the third type of syntax element is a second preset value, it is determined that the current node includes duplicate points. Exemplarily, the first preset value may be 1, and the second preset value may be 0.

Exemplarily, the third type of syntax element is identification information of a sequence-level syntax element geomRemoveDuplicateFlag, and the value of geomRemoveDuplicateFlag being 1 indicates that the point cloud sequence does not include the duplicate points, that is, all slices in the point cloud sequence do not include the duplicate points. The specific definition of the sequence header is shown in Table 2.

TABLE 2
Definition of sequence header

| | Descriptor |
|---|---|
| sequence_header( ) { | |
| profile_id | u(8) |
| level_id | u(8) |
| marker_bit | f(1) |
| bounding_box_offset_x_upper | u(16) |
| marker_bit | f(1) |
| bounding_box_offset_x_lower | u(16) |
| marker_bit | f(1) |
| bounding_box_offset_y_upper | u(16) |
| marker_bit | f(1) |
| bounding_box_offset_y_lower | u(16) |
| marker_bit | f(1) |
| bounding_box_offset_z_upper | u(16) |
| marker_bit | f(1) |
| bounding_box_offset_z_lower | u(16) |
| marker_bit | f(1) |
| bounding_box_size_width_upper | u(16) |
| marker_bit | f(1) |
| bounding_box_size_width_lower | u(16) |
| marker_bit | f(1) |
| bounding_box_size_height_upper | u(16) |
| marker_bit | f(1) |
| bounding_box_size_height_lower | u(16) |
| marker_bit | f(1) |
| bounding_box_size_depth_upper | u(16) |
| marker_bit | f(1) |
| bounding_box_size_depth_lower | u(16) |
| marker_bit | f(1) |
| quant_step_upper | u(16) |
| marker_bit | f(1) |
| quant_step_lower | u(16) |
| geomRemoveDuplicateFlag | u(1) |
| marker_bit | f(1) |
| attribute_present_flag | |
| if (attribute_present_flag) { | |
| attribute_adapt_pred | u(1) |
| colorQuantParam | ue(v) |
| reflQuantParam | ue(v) |
| sps_multi_set_flag | u(1) |
| maxNumAttributesMinus1 | u(4) |
| } | |
| byte_alignment( ) | |
| } | |

At S702, when it is determined that the volume of the bounding box and the number of points of the current node meet a preset condition, the current node is reconstructed to determine a reconstructed point cloud of the current node.

It is to be noted that the preset condition is a restriction condition for the volume of the bounding box and the number of points of the current node. When the volume of the bounding box and the number of points of the current node meet the preset condition, it indicates that the volume of the bounding box and the number of points are decoded correctly, and the subsequent decoding operations may be continued.

In some embodiments, the method further includes: when it is determined that the volume of the bounding box and the number of points of the current node meet the preset condition, decoding the geometric information of the current node. Accordingly, the operation of reconstructing the current node to determine the reconstructed point cloud of the current node includes an operation of reconstructing the current node according to the geometric information to determine the reconstructed point cloud of the current node.

It is to be noted that whether the geometric information of the current node may be successfully decoded is determined according to the number of points and the volume of the bounding box of the current node. the case that the number of points and the volume of the bounding box of the current node meet the preset conditions is a prerequisite for successfully decoding the geometric information, and it may also be understood as a prerequisite for successfully reconstructing the point cloud.

In some embodiments, the method further includes operations that the bitstream is decoded to determine attribute information of the current node; and the point cloud of the current node is reconstructed according to the attribute information and the geometric information of the current node to determine the reconstructed point cloud of the current node.

In some embodiments, the method further includes operations that when it is determined that the volume of the bounding box and the number of points of the current node do not meet the preset condition, it is determined that there is an error in decoding the current node.

In some embodiments, if it is determined that there is an error in decoding the current node, the decoding operation for the current node may be terminated early, that is, the reconstruction operation for the point cloud is terminated in advance. In some other embodiments, when the current node is a point cloud slice, if it is determined that there is an error in decoding the current node, the decoding operation for the current point cloud tile/current point cloud frame/current point cloud sequence in which the current point cloud slice is located may be terminated early.

In some embodiments, the method further includes an operation that: when it is determined that the volume of the bounding box and the number of points of the current node do not meet the preset condition, it is determined that there is an error in decoding the geometric information of the current node. If it is determined that there is an error in decoding, the decoding operation for the geometry information of the current node may be terminated early. In some other embodiments, when the current node is a point cloud slice, if it is determined that there is an error in decoding the current node, the decoding operation for the geometric information of the current point cloud tile/current point cloud frame/current point cloud sequence in which the current point cloud slice is located may be terminated early.

In some embodiments, the method further includes an operation that: when it is determined that the volume of the bounding box and the number of points of the current node do not meet the preset condition, decoding the geometric information of the current node is stopped, or it is determined that there is an error in decoding the geometric information of the current node. It is to be noted that since the point cloud reconstruction requires the information such as the geometric information and the attribute information, the decoding operation for other information such as attribute information may be terminated if there is an error in decoding the geometric information.

In some embodiments, the method further includes an operation that: when it is determined that the volume of the bounding box and the number of points of the current node do not meet the preset condition, fault alert information is generated.

In some embodiments, the preset condition includes that the number of points is less than or equal to the volume of the bounding box.

It is to be noted that if the operation of quantizing and removing duplicate points is performed on the current node, in this case, there will be no duplicate points in the current node, and there are at most (length×width×height) points in the bounding box of the current node. Therefore, the number of points of the current node (pointCount/num_points) and the volume of the bounding box (length×width×height) must meet the following relationship:

$$pointCount \leq length \times width \times height$$

In some embodiments, when it is determined that the volume of the bounding box and the number of points of the current node do not meet the preset condition, the number of points of the current node is initialized to the volume of the bounding box.

It is to be noted that once the volume of the bounding box and the number of points of the current node do not meet the preset conditions, it may be determined that there is an error in decoding the syntax element for the current node, and the subsequent decoding operation may be terminated in advance. However, it may not exclude the case that the decoding side needs to continue decoding until the decoder crashes. Therefore, in some embodiments, when the preset condition is not met, the number of points of the current node is initialized to the volume of the bounding box, and the subsequent decoding operation is continued.

The embodiments of the present disclosure provide a decoding method, which ensures the robustness and stability of the decoder without affecting the decoding efficiency by defining the relationship between the number of points (also referred to as “reconstruction points”) of the current node and the volume of the bounding box. In some cases, if the operation of removing duplicate points is performed on the current node, there will be no duplicate points in the current node, and there are at most (length×width×height) points in the bounding box of the current node. That is, the number of points in the current node must be less than or equal to the volume of the bounding box (length×width×height). By defining the relationship between the number of points and the volume of the bounding box, the robustness and stability of the decoder may be ensured without affecting the decoding efficiency.

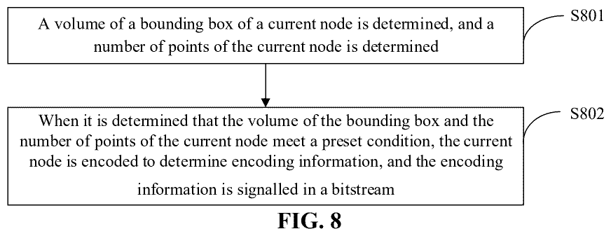

In an embodiment of the present disclosure, referring to FIG. 8, FIG. 8 illustrates a schematic flowchart of an encoding method provided by the embodiment of the present disclosure. As illustrated in FIG. 8, the method may include operations S801 to S802.

At S801, a volume of a bounding box of a current node is determined, and a number of points of the current node is determined.

In some embodiments, the current node is a node, in which the duplicate points are removed, in the point cloud. Exemplarily, the current node includes at least one of: a current point cloud sequence, a current point cloud frame, a current point cloud tile, or a current point cloud slice.

In some embodiments, at the encoding side, the coordinate transformation is performed on the geometric information of the point cloud of each node, so that the entire point cloud is included in a bounding box. The bounding box is preprocessed to obtain the current node in the embodiments of the present disclosure. The pre-processing process includes quantifying and removing duplicate points. The quantization mainly plays the role of scaling. Because the quantization is rounded, the geometric information of part of the points is the same, and it is determined whether to remove the duplicate points based on the parameter.

In some embodiments, when the current node is a point cloud tile, it is determined that the entire point cloud sequence is divided into a plurality of point cloud tiles according to the parameter configuration, and each point cloud tile is processed as a single independent point cloud.

In some embodiments, when the current node is a point cloud slice, it is determined that the entire point cloud sequence is divided into a plurality of point cloud slices according to a parameter configuration, and each point cloud slice is processed as a single independent point cloud.

At S802, when it is determined that the volume of the bounding box and the number of points of the current node meet a preset condition, the current node is encoded to determine encoding information, and the encoding information is signalled in a bitstream.

It is to be noted that the preset condition is a restriction condition for the volume of the bounding box and the number of points of the current node. When the volume of the bounding box and the number of points of the current node meet the preset condition, it indicates that the geometry information of the current node is encoded correctly, and the subsequent encoding operations may be continued.

In some embodiments, the method further includes an operation that: when it is determined that the volume of the bounding box and the number of points of the current node meet the preset condition, the geometric information of the current node is encoded.

It is to be noted that, whether the geometric information of the current nodemay be successfully encoded is determined according to the number of points and the volume of the bounding box of the current node. The case that the number of points and the volume of the bounding box of the current node meet the preset conditions is a prerequisite for successfully encoding the geometric information, and it may also be understood as a basis for successfully encoding the point cloud.

In some embodiments, the method further includes an operation that: when it is determined that the volume of the bounding box and the number of points of the current node meet the preset condition, attribute information of the current node is encoded.

In some embodiments, the method further includes an operation that: when it is determined that the volume of the bounding box and the number of points of the current node do not meet the preset condition, it is determined that there is an error in encoding the current node.

In some embodiments, if it is determined that there is an error in encoding, the encoding operation for the current node may be terminated early. In some other embodiments, when the current node is a point cloud slice, if it is determined that there is an error in encoding, the encoding operation for the current point cloud tile/current point cloud frame/current point cloud sequence in which the current point cloud slice is located may be terminated early.

In some embodiments, the method further includes an operation that: when it is determined that the volume of the bounding box and the number of points of the current node do not meet the preset condition, it is determined that there is an error in encoding the geometric information of the current node. If it is determined that there is an error in encoding, the encoding operation for the current node may be terminated early. In some other embodiments, when the current node is a point cloud slice, if it is determined that there is an error in encoding the current node, the encoding operation for the current point cloud tile/current point cloud frame/current point cloud sequence in which the current point cloud slice is located may be terminated early.

In some embodiments, the method further includes operations that: when it is determined that the volume of the bounding box and the number of points of the current node do not meet the preset condition, encoding the attribute information of the current node is stopped, or it is determined that there is an error in encoding the attribute information. It is to be noted that since the point cloud reconstruction requires the information such as the geometric information and the attribute information, the encoding operation for other information such as attribute information may be terminated if there is an error in encoding the geometric information.

In some embodiments, the method further includes an operation that: when it is determined that the volume of the bounding box and the number of points of the current node do not meet the preset condition, fault alert information is generated.

In some embodiments, the preset condition includes that the number of points is less than or equal to the volume of the bounding box.

It is to be noted that if the operation of quantizing and removing duplicate points is performed on the current node, in this case, there will be no duplicate points in the current node, and there are at most (length×width×height) points in the bounding box of the current node. Therefore, the number of points of the current node (pointCount/num_points) and the volume of the bounding box (length×width×height) must meet the following relationship:

$$pointCount \leq length \times width \times height$$

In some embodiments, when it is determined that the volume of the bounding box and the number of points of the current node do not meet the preset condition, the number of points of the current node is initialized to the volume of the bounding box.

It is to be noted that once the volume of the bounding box and the number of points of the current node do not meet the preset conditions, it may be determined that there is an error in encoding the current node, and the subsequent encoding operations may be terminated in advance. However, it may not exclude the case that the encoding side needs to continue encoding until the encoder crashes. Therefore, in some embodiments, when the preset condition is not met, the number of points of the current node is initialized to the volume of the bounding box, and the subsequent encoding operation is continued.

In some embodiments, the operation that the current node is encoded to determine the encoding information includes an operation that identification information of a first type of syntax element for the current node is determined. Herein the identification information of the first type of syntax element is used for indicating the volume of the bounding box of the current node. The identification information of the first type of syntax element may be understood as a set including identification information of one or more syntax elements.

It is to be noted that the first type of syntax element may be a high-level syntax element for the current node, and is used to indicate the bounding box volume of the current node. The first type of syntax element includes at least one of: a sequence-level syntax element, a frame-level syntax element, a tile-level syntax element, and a slice-level syntax element. In some embodiments, when the current node is a point cloud slice, the first type of syntax element is a slice-level syntax element, and may be located in the slice header. When the current node is a point cloud tile, the first type of syntax element is a tile-level syntax element, and may be located in the tile header. When the current node is a point cloud frame, the first type of syntax element is a frame-level syntax element, and may be located in the frame header. When the current node is a point cloud sequence, the first type of syntax element is a sequence-level syntax element, and may be located in the sequence header.

It is to be noted that the identification information of the first type of syntax element is used to directly indicate the volume of the bounding box, or the first type of syntax element is used to indicate a length, width and height of the bounding box of the current node, and the bounding box volume is further obtained according to the product of the length, width and height of the bounding box.

Exemplarily, the first type of syntax element includes: identification information of a first syntax element, identification information of a second syntax element, and identification information of a third syntax element. The identification information of the first syntax element is used to indicate the length of the bounding box, the identification information of the second syntax element is used to indicate the width of the bounding box, and the identification information of the third syntax element is used to indicate the height of the bounding box.

the operation that the identification information of the first type of syntax element for the current node is determined includes operations that: the identification information of the first syntax element is determined according to the length of the bounding box of the current node; the identification information of the second syntax element is determined according to the width of the bounding box of the current node; and the identification information of the third syntax element is determined according to the height of the bounding box of the current node.

In some embodiments, the identification information of the first syntax element includes identification information of at least two sub-syntax elements, the identification information of the second syntax element includes identification information of at least two sub-syntax elements, and the identification information of the third syntax element includes identification information of at least two sub-syntax elements.

It is to be noted that the size of the bounding box may be indicated by two or more sub-syntax elements, and each sub-syntax element is used to indicate the value at partial positions of the size of the bounding box. For example, the identification information of the at least two sub-syntax elements includes identification information of a first sub-syntax element and identification information of a second sub-syntax element. The identification information of the first sub-syntax element is used for indicating values of low bits of the size of the bounding box, and the identification information of the second sub-syntax element is used for indicating values of high bits of the size of the bounding box.

Exemplarily, taking the current node being a point cloud slice as an example, and the identification information of the first type of syntax element includes followings.

A higher part of bits of a logarithmic size of the slice bounding box in X-direction, which is referred to as gsh_bounding_box_nodeSizeXLog2_upper, is an unsigned integer and represents \bits higher than the 16-th bit of the logarithmic size of the slice bounding box in X-direction.

A lower part of the bits of the logarithmic size of the slice bounding box in X-direction, which is referred to as gsh_bounding_box_nodeSizeXLog2_lower, is an unsigned integer and represents the lower 16 bits of the logarithmic size of the slice bounding box in X-direction.

The logarithmic size of the slice bounding box in X direction is:

gsh_bounding_box_nodeSizeXLog2=(gsh_bounding_box_nodeSizeXLog2_upper)<<16+
gsh_bounding_box_nodeSizeXLog2_lower

A higher part of bits of a logarithmic size of the slice bounding box in Y-direction, which is referred to as gsh_bounding_box_nodeSizeYLog2_upper, is an unsigned integer and represents bits higher than the 16-th bit of the logarithmic size of the slice bounding box in Y-direction.

A lower part of the bits of the logarithmic size of the slice bounding box in Y-direction, which is referred to as gsh_bounding_box_nodeSizeYLog2_lower, is an unsigned integer and represents lower 16 bits of the logarithmic size of the slice bounding box in Y-direction.

The logarithmic size of the slice bounding box in Y direction is:

gsh_bounding_box_nodeSizeYLog2=(gsh_bounding_box_nodeSizeYLog2_upper)<<16+
gsh_bounding_box_nodeSizeYLog2_lower

A higher part of bits of a logarithmic size of the slice bounding box in Z-direction, which is referred to as gsh_bounding_box_nodeSizeZLog2_upper, is an unsigned integer and represents bits higher than the 16-th bit of the logarithmic size of the slice bounding box in Z-direction.

A lower part of the bits of the logarithmic size of the slice bounding box in Z-direction, which is referred to as gsh_bounding_box_nodeSizeZLog2_lower, is an unsigned integer and represents the lower 16 bits of the logarithmic size of the slice bounding box in Z-direction.

The logarithmic size of the slice bounding box in Z direction is:

gsh_bounding_box_nodeSizeZLog2=(gsh_bounding_box_nodeSizeZLog2_upper)<<16+
gsh_bounding_box_nodeSizeZLog2_lower

In some embodiments, the operation that the current node is encoded to determine the encoding information includes an operation that identification information of a second type of syntax element for the current node is determined. Herein the identification information of the second type of syntax element is used for indicating a number of points of the current node. The identification information of the second type of syntax element may be understood as a set including identification information of one or more syntax elements.

It is to be noted that the second type of syntax element may be a high-level syntax element for the current node, and is used to indicate a number of point cloud reconstruction points of the current node. The second type of syntax element includes at least one of: a sequence-level syntax element, a frame-level syntax element, a tile-level syntax element, or a slice-level syntax element. In some embodiments, when the current node is a point cloud slice, the second type of syntax element is a slice-level syntax element, and may be located in the slice header. When the current node is a point cloud tile, the second type of syntax element is a tile-level syntax element, and may be located in the tile header. When the current node is a point cloud frame, the second type of syntax element is a frame-level syntax element, and may be located in the frame header. When the current node is a point cloud sequence, the second type of syntax element is a sequence-level syntax element, and may be located in the sequence header.

In some embodiments, the identification information of the second syntax element includes identification information of at least two sub-syntax elements.

It is to be noted that the number of points may be indicated by using two or more sub-syntax elements, and each sub-syntax element is used to indicate values of partial positions of the number of points. For example, the identification information of the at least two sub-syntax elements includes identification information of a third sub-syntax element and identification information of a fourth sub-syntax element. The identification information of the third sub-syntax element is used for indicating values of lower bits of the number of points, and the identification information of the fourth sub-syntax element is used for indicating values of higher bits of the number of points.

Exemplarily, taking the current node being a point cloud slice as an example, and the identification information of the second type of syntax element includes followings.

A higher part of bits of the number of points contained in the slice, which is referred to as num_points_upper, is an unsigned integer and represents bits higher than the 16-th bit of the number of points contained in the slice.

A lower part of the bits of the number of points contained in the slice, which is referred to as num_points_lower, is an unsigned integer and represents the lower 16 bits of the number of points contained in the slice.

The number of points contained in the slice is: num_points=((num_points_upper<<16)+num_points_lower).

The relationship between the number of points num_points and gsh_bounding_box_nodeSizeXLog2, gsh_bounding_box_nodeSize YLog2, and gsh_bounding_box_nodeSizeZLog2 is defined as following: num_points<=(gsh_bounding_box_nodeSizeXLog2xgsh_bounding_box_nodeSize YLog2x gsh_bounding_box_nodeSizeZLog2)

Exemplarily, the embodiments of the present disclosure define the relationship between the number of points in the point cloud slice and the volume of the bounding box to ensure the stability of the codec. The specific definition of the geometric slice header is shown in Table 1.

In some embodiments, the operation that the current node is encoded to determine the encoding information includes an operation that: identification information of a third type of syntax element for the current node is determined. Herein the identification information of the third type of syntax element is used for indicating that the current node is the node in which duplicate points are removed. The identification information of the third type of syntax element may be understood as a set including identification information of one or more syntax elements.

The third type of syntax element may be a high-level syntax element for the current node, and is used to indicate whether there are duplicate points in the current node. The third type of syntax element includes at least one of: a sequence-level syntax element, a frame-level syntax element, a tile-level syntax element, or a slice-level syntax element. In some embodiments, the third type of syntax element is a sequence-level syntax element, and is used to indicate that there are no duplicate points in the point cloud sequence in which the current node is located. In some embodiments, the third type of syntax element is a frame level syntax element, and is used to indicate that there are no duplicate points in the point cloud frame in which the current node is located. In some embodiments, the third type of syntax element is a tile level syntax element, and is used to indicate that there are no duplicate points in the point cloud tile in which the current node is located. In some embodiments, the third type of syntax element is a slice level syntax element, and is used to indicate that there are no duplicate points in the current point cloud slice.

In some embodiments, when a value of the identification information of the third type of syntax element is a first value, it is determined that the current node is a node in which the duplicate points are removed. When the value of the identification information of the third type of syntax element is a second value, it is determined that the current node includes duplicate points. Exemplarily, the first preset value may be 1, and the second preset value may be 0.

In some embodiments, at the encoding side, the bounding box of the current node is processed by quantizing and removing duplicate points, when it is determined that the current node has no duplicate points, and the value of the identification information of the third syntax element is set to the first value, otherwise, the value of the identification information of the third syntax element is set to the second value.

Exemplarily, the third type of syntax element is identification information of a sequence-level syntax element geomRemoveDuplicateFlag, and the value of geomRemoveDuplicateFlag being 1 indicates that the point cloud sequence does not include the duplicate points, that is, all slices in the point cloud sequence do not include the duplicate points. The specific definition of the sequence header is shown in Table 2.

The embodiments of the present disclosure provide an encoding method, which ensures the robustness and stability of the encoder without affecting the encoding efficiency by defining the relationship between the number of points of the current node and the volume of the bounding box. In some cases, if the operation of removing duplicate points is performed on the current node, there will be no duplicate points in the current node, and there are at most (length×width×height) points in the bounding box of the current node. That is, the number of points in the current node must be less than or equal to the volume of the bounding box (length×width×height). By defining the relationship between the number of points and the volume of the bounding box, the robustness and stability of the decoder may be ensured without affecting the encoding efficiency.

Further, an embodiment of the present disclosure further provides a bitstream. The bitstream is generated by performing bit encoding based on the information to be encoded. Herein the information to be encoded includes at least one of: identification information of a first-type syntax element for indicating a bounding box volume of a current node, identification information of a second type of syntax element for indicating a number of points of the current node, or identification information of a third type syntax element for indicating that the current node is a node in which the duplicate points are removed.

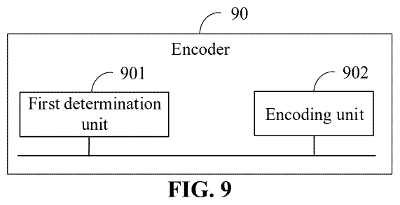

In another embodiment of the present disclosure, on the basis of the same inventive concept of the foregoing embodiments, referring to FIG. 9, FIG. 9 illustrates a schematic structure diagram of an encoder according to an embodiment of the present disclosure. As illustrated in FIG. 9, the encoder 90 may include: a first determination unit 901 and an encoding unit 902.

The first determination unit 901 is configured to: determine a volume of a bounding box of a current node, and determine a number of points of the current node.

The encoding unit 902 is configured to: when it is determined that the volume of the bounding box and the number of points of the current node meet a preset condition, encode the current node to determine the encoding information, and signal the encoding information in a bitstream.

In some embodiments, the preset condition includes that the number of points is less than or equal to the volume of the bounding box.

In some embodiments, the encoding unit 902 is configured to: when it is determined that the volume of the bounding box and the number of points of the current node do not meet the preset condition, initialize the number of points of the current node to the volume of the bounding box.

In some embodiments, the encoding unit 902 is configured to: determine identification information of a first type of syntax element for the current node. Herein the identification information of the first type of syntax element is used for indicating the volume of the bounding box of the current node.

In some embodiments, the first type of syntax element includes: identification information of a first syntax element, identification information of a second syntax element, and identification information of a third syntax element.

In some embodiments, the encoding unit 902 is configured to: determine the identification information of the first syntax element according to a length of the bounding box of the current node; determine the identification information of the second syntax element according to a width of the bounding box of the current node; and determine the identification information of the third syntax element according to a height of the bounding box of the current node.

In some embodiments, the identification information of the first syntax element includes identification information of at least two sub-syntax elements, the identification information of the second syntax element includes identification information of at least two sub-syntax elements, and the identification information of the third syntax element includes identification information of at least two sub-syntax elements.

In some embodiments, the identification information of the at least two sub-syntax elements includes identification information of a first sub-syntax element and identification information of a second sub-syntax element. The identification information of the first sub-syntax element is used for indicating values of lower bits of a size of the bounding box, and the identification information of the second sub-syntax element is used for indicating values of higher bits of the size of the bounding box.

In some embodiments, the encoding unit 902 is configured to: determine identification information of a second type of syntax element for the current node. The identification information of the second type of syntax element is used for indicating the number of points of the current node.

In some embodiments, the identification information of the second type of syntax element includes identification information of at least two sub-syntax elements.

In some embodiments, the identification information of the at least two sub-syntax elements includes identification information of a third sub-syntax element and identification information of a fourth sub-syntax element. The identification information of the third sub-syntax element is used for indicating values of lower bits of the number of points, and the identification information of the fourth sub-syntax element is used for indicating values of higher bits of the number of points.

In some embodiments, the current node includes at least one of: a current point cloud sequence, a current point cloud frame, a current point cloud tile, or a current point cloud slice.

In some embodiments, the encoding unit 902 is configured to: when it is determined that the volume of the bounding box and the number of points of the current node meet the preset condition, encode geometric information of the current node.

In some embodiments, the encoding unit 902 is configured to: when the volume of the bounding box and the number of points do not meet the preset condition, determine that there is an error in encoding the current node.

In some embodiments, the encoding unit 902 is configured to: when the volume of the bounding box and the number of points do not meet the preset condition, determine that there is an error in encoding geometric information of the current node.

In some embodiments, the current node is a node in which the duplicate points are removed.

In some embodiments, the encoding unit 902 is configured to determine the identification information of a third type of syntax element for the current node. Herein the identification information of the third type of syntax element is used for indicating that the current node is the node in which the duplicate points are removed.

It is to be understood that in the embodiments of the present disclosure, the “unit” may be part of a circuit, part of a processor, part of programs or software, etc., or, it may also be modular or non-modular. Further, in the embodiments, the various functional units may be integrated in one processing unit, or each unit may exist physically alone, or two or more units may be integrated in one unit. The above-mentioned integrated unit may be implemented either in the form of hardware or in the form of software function module.

When the integrated unit is implemented in the form of a software function module and does not be sold or used as an independent product, it may also be stored in a computer-readable storage medium. Based on such understanding, the technical solution of the present embodiments in essence or the part contributing to the related art or all or part of the technical solution may be embodied in the form of software product, and the software product is stored in a storage medium and includes several instructions for enabling a computer device (which can be a personal computer, a server, a network device, etc.) or processor to perform all or part of the steps of the method of the present embodiments. The aforementioned storage media include: U disk, mobile hard disk, read-only memory (ROM), random access memory (RAM), magnetic disk or optical disk and other media that can store program code.

Therefore, the embodiments of the present disclosure provide a computer readable storage medium, applied to the encoder 90. The computer readable storage medium stores the computer program which, when implemented by the first processor, implement the method of any one of the preceding embodiments.

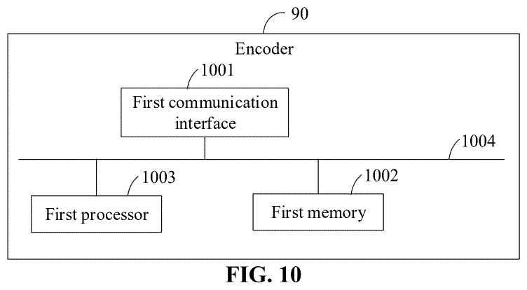

Based on the composition of the encoder 90 and the computer readable storage medium, referring to FIG. 10, FIG. 10 illustrates a structural schematic diagram of a specific hardware of an encoder 90 provided by an embodiment of the present disclosure. As illustrated in FIG. 10, the encoder 90 may include: a first communication interface 1001, a first memory 1002 and a first processor 1003. These components are coupled together via a first bus system 1004. It is to be understood that the first bus system 1004 is used to implement the connection communication between these components. In addition to a data bus, the first bus system 1004 further includes a power bus, a control bus and a status signal bus. However, for the purpose of clarity, the various buses are marked as the first bus system 1004 in FIG. 10.

The first communication interface 1001 is configured to receive or transmit the signal in the process of transmitting or receiving information with other external network elements.

The first memory 1002 is configured to store a computer program executable on the first processor 1003.

The first processor 1003 is configured to, when executing the computer program:
determine a volume of a bounding box of a current node and determine a number of points of the current node; and
when it is determined that the volume of the bounding box and the number of points of the current node meet a preset condition, encode the current node to determine encoding information, and signal the encoding information in a bitstream.

It is to be understood that the first memory 1002 in the embodiments of the present disclosure may be a volatile memory or a non-volatile memory, or may include both the volatile and non-volatile memory. The nonvolatile memory may be a read-only memory (ROM), a programmable ROM (PROM), an erasable Prom (EPROM), an electrically erasable EPROM (EEPROM) or a flash memory. The volatile memory may be a random access memory (RAM), which is used as an external cache. By way of exemplary illustration, but not limitation, many forms of RAM are available, such as a static RAM (SRAM), a dynamic RAM (DRAM), synchronous DRAM (SDRAM), a double data rate SDRAM (DDRSDRAM, an enhanced SDRAM (ESDRAM), a synchlink DRAM (SLDRAM) and a direct Rambus RAM (DR RAM). The first memory 1002 of the systems and methods described herein is intended to include, but is not limited to, these and any other suitable types of memory.

The first processor 1003 may be an integrated circuit chip, which has signal processing capability. During the implementation, the various operations of the above methods may be implemented by the integrated logic circuit of hardware in the first processor 1003 or instructions in the form of software. The above first processor 1003 may be general purpose processors, digital signal processors (DSPs), application specific integrated circuits (ASICs), field programmable gate arrays (FPGAs) or other programmable logic devices, discrete gate or transistor logic devices, and discrete hardware components. The disclosed methods, operations and logic block diagrams in the embodiments of the present disclosure may be implemented or executed. The general-purpose processor may be a microprocessor or the processor may be any conventional processor or the like. The operations of the methods disclosed in connection with the embodiments of the present disclosure may be directly embodied as being executed by a hardware decoding processor, or by the combination of the hardware and software modules in the decoding processor. The software module can be located in a random memory, a flash memory, a read-only memory, a programmable read-only memory or an electrically erasable programmable memory, a register and other mature storage media in the art. The storage medium is located in the first memory 1002, and the first processor 1003 reads the information in the first memory 1002 and completes the operations of the above method in combination with its hardware.

It is to be understood that the embodiments described herein may be implemented in hardware, software, firmware, middleware, microcode or a combination thereof. For the hardware implementation, the processing unit may be implemented in one or more Application Specific Integrated Circuits (ASIC), Digital Signal Processors (DSPD), Digital Signal Processing Devices (DSPD), Programmable Logic Devices (PLD), Field-Programmable Gate Arrays (FPGA), general purpose processors, controllers, microcontrollers, microprocessors, other electronic units for performing the functions described herein, or a combination thereof. For the software implementation, the techniques described herein may be implemented by modules (e.g. procedures, functions, etc.) that perform the functions described herein. The software code may be stored in the memory and executed by a processor. The memory may be implemented in the processor or outside the processor.

Alternatively, as another embodiment, the first processor 1003 is further configured to, when running the computer program, perform the method of any of the preceding embodiments.

The embodiments of the present disclosure provide an encoder. In the encoder, the relationship between the number of points and the volume of the bounding box of the current node is defined, such that the robustness and the stability of the encoder are ensured without affecting the encoding efficiency. In some cases, if the operation of removing duplicate points is performed on the current node, there will be no duplicate points in the current node, and there are at most (length×width×height) points in the bounding box of the current node. That is, the number of points of the current node must be less than or equal to the volume of the bounding box (length×width×height). By defining the relationship between the number of points and the volume of the bounding box, the robustness and stability of the decoder may be ensured without affecting the encoding efficiency.

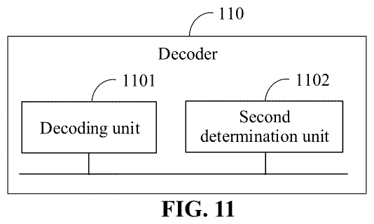

In another embodiment of the present disclosure, on the basis of the same inventive concept of the foregoing embodiments, referring to FIG. 11, FIG. 11 illustrates a structural schematic diagram of a decoder 110 according to an embodiment of the present disclosure. As illustrated in FIG. 11, the decoder 110 may include: a decoding unit 1101 and a second determination unit 1102.

The decoding unit 1101 is configured to: determine a volume of a bounding box of a current node, and determine a number of points of the current node.

The second determination unit 1102 is configured to: when it is determined that the volume of the bounding box and the number of points of the current node meet a preset condition, decode the current node to determine a reconstructed point cloud of the current node.

In some embodiments, the preset condition includes that the number of points is less than or equal to the volume of the bounding box.

In some embodiments, the second determination unit 1102 is configured to: when it is determined that the volume of the bounding box and the number of points of the current node do not meet the preset condition, initialize the number of points of the current node to the volume of the bounding box.

In some embodiments, the decoding unit 1101 is configured to: decode the bitstream to determine identification information of a first type of syntax element for the current node; and determine the volume of the bounding box of the current node according to the identification information of the first type of syntax element.

In some embodiments, the first type of syntax element includes: identification information of a first syntax element, identification information of a second syntax element, and identification information of a third syntax element.

The decoding unit 1101 is configured to: determine a length of the bounding box according to the identification information of the first syntax element; determine a width of the bounding box according to the identification information of the second syntax element; determine a height of the bounding box according to the identification information of the third syntax element; and determine the volume of the bounding box of the current node by calculating a product of the length, the width, and the height of the bounding box of the current node.

In some embodiments, the identification information of the first syntax element includes identification information of at least two sub-syntax elements, the identification information of the second syntax element includes identification information of at least two sub-syntax elements, and the identification information of the third syntax element includes identification information of at least two sub-syntax elements.

In some embodiments, the identification information of the at least two sub-syntax elements includes identification information of a first sub-syntax element and identification information of a second sub-syntax element; the identification information of the first sub-syntax element is used for indicating the values of the lower bits of a size of the bounding box, and the identification information of the second sub-syntax element is used for indicating values of higher bits of the size of the bounding box.

In some embodiments, the decoding unit 1101 is configured to: decode a bitstream to determine identification information of a second type of syntax element for the current node; and determine the number of points of the current node according to the identification information of the second type of syntax element.

In some embodiments, the identification information of the second type of syntax element includes identification information of at least two sub-syntax elements.

In some embodiments, the identification information of the at least two sub-syntax elements includes identification information of a third sub-syntax element and the identification information of the fourth sub-syntax element; the identification information of the third sub-syntax element is used for indicating the values of lower bits of the number of points, and the identification information of the fourth sub-syntax element is used for indicating values of higher bits of the number of points.

In some embodiments, the current node comprises at least one of: a current point cloud sequence, a current point cloud frame, a current point cloud tile, or a current point cloud slice.

In some embodiments, the decoding unit 1101 is configured to: when it is determined that the volume of the bounding box and the number of points of the current node meet the preset condition, decode the geometric information of the current node.

The second determination unit 1102 is configured to reconstruct the current node according to the geometric information to determine the reconstructed point cloud of the current node.

In some embodiments, the second determination unit 1102 is configured to: when the volume of the bounding box and the number of points do not meet the preset condition, determine that there is an error in decoding the current node.

In some embodiments, the second determination unit 1102 is configured to: when the volume of the bounding box and the number of points do not meet the preset condition, determine that there is an error in decoding the geometric information of the current node.

In some embodiments, the current node is a node in which the duplicate points are removed.

In some embodiments, the decoding unit 1101 is configured to: decode a bitstream to determine identification information of a third type of syntax element for the current node; and determine that the current node is a node in which the duplicate points are removed according to the identification information of the third type of syntax element.

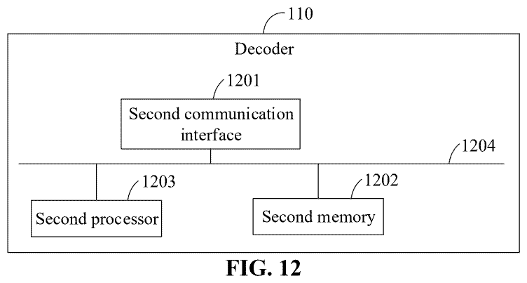

Based on the composition of the decoder 110 and the computer readable storage medium, referring to FIG. 12, FIG. 12 illustrates a structural schematic diagram of a specific hardware of a decoder 110 provided by an embodiment of the present disclosure. As illustrated in FIG. 12, the decoder 110 may include a second communication interface 1201, a second memory 1202 and a second processor 1203. These components are coupled together via a second bus system 1204. It is to be understood that the second bus system 1204 is used to implement the connection communication between these components. In addition to a data bus, the second bus system 1204 further includes a power bus, a control bus and a status signal bus. However, for the purpose of clarity, the various buses are marked as the second bus system 1204 in FIG. 12.

The second communication interface 1201 is configured to receive or transmit the signal in the process of transmitting or receiving information with other external network elements.

The second memory 1202 is configured to store a computer program executable on the second processor 1203.

The second processor 1203 is configured to, when running the computer program performing the following operation.

A volume of a bounding box of a current node is determined, and a number of points of the current node is determined; and

when it is determined that the volume of the bounding box and the number of points of the current node meet a preset condition, the current node is reconstructed to determine a reconstructed point cloud of the current node.

Alternatively, as another embodiment, the second processor 1203 is further configured to, when running the computer program, perform the method of any of the preceding embodiments.

It is to be understood that the second memory 1202 is similar in hardware function to the first memory 1002, and the second processor 1203 is similar in hardware function to the first processor 1003, and will not be elaborated here.

The embodiments of the present disclosure provide a decoder. In the decoder, a relationship between the number of points (also referred to as “reconstruction points”) and a volume of a bounding box of a current node is defined, such that the robustness and the stability of the decoder are ensured without affecting the decoding efficiency. In some cases, if the operation of removing duplicate points is performed on the current node, there will be no duplicate points in the current node, and there are at most (length×width×height) points in the bounding box of the current node. That is, the number of points in the current node must be less than or equal to the volume of the bounding box (length×width×height). By defining the relationship between the number of points and the volume of the bounding box, the robustness and stability of the decoder may be ensured without affecting the decoding efficiency.

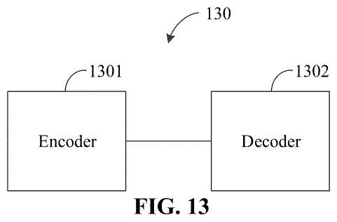

In another embodiment of the present disclosure, referring to FIG. 13, FIG. 13 illustrates a structural schematic diagram of an encoding and decoding system according to an embodiment of the present disclosure. As illustrated in FIG. 13, the encoding and decoding system 130 may include an encoder 1301 and a decoder 1302.

In the embodiments of the present disclosure, the encoder 1301 may be an encoder described in any one of the aforementioned embodiments, and the decoder 1302 may be a decoder described in any one of the aforementioned embodiments.

It is to be noted that the terms used herein “including”, “comprising” or any other variation thereof are intended to encompass non-exclusive inclusion, so that a process, a method, an article or a device that includes a set of elements includes not only those elements but also other elements that are not explicitly listed, or also elements inherent to such a process, method, article or device. In the absence of further limitations, an element defined by the phrase “includes an . . . ” does not exclude the existence of another identical element in the process, method, article or device in which the element is included.

The above serial numbers of the embodiments of the present disclosure are for description only and do not represent the advantages and disadvantages of the embodiments.

The methods disclosed in several embodiments of the method provided in the disclosure may be arbitrarily combined as long as there is no conflict therebetween to obtain a new embodiment of a method.

The features disclosed in several embodiments of the product provided in the disclosure may be arbitrarily combined as long as there is no conflict therebetween to obtain a new embodiment of a product.

The features disclosed in several embodiments of the method or device provided in the disclosure may be arbitrarily combined as long as there is no conflict therebetween to obtain a new embodiment of a method or a device.

The descriptions above are only the specific embodiments of the present disclosure, and are not intended to limit the scope of protection of the embodiments of the present disclosure. Any change and replacement are obvious within the technical scope of the embodiments of the present for those skilled in the art, and fall within the protection scope of the present disclosure. Therefore, the scope of protection of the embodiments of the present disclosure shall be subject to the scope of protection of the claims.

### INDUSTRIAL PRACTICALITY

The embodiments of the present disclosure provide an encoding method, a decoding method, a bitstream, an encoder, a decoder, and a storage medium. The method includes: determining a volume of a bounding box of a current node, and determining a number of points of the current node; and when it is determined that the volume of the bounding box and the number of points of the current node meet a preset condition, reconstructing the current node to determine a reconstructed point cloud of the current node. As such, if the operation of removing duplicate points is performed on the current node, there will be no duplicate points in the current node, and there are at most (length×width×height) points in the bounding box of the current node. That is, the number of points in the current node must be less than or equal to the volume of the bounding box. By defining the relationship between the number of points and the volume of the bounding box, the robustness and stability of the encoder and decoder may be ensured without affecting the encoding and decoding efficiency.

1. A method for decoding, applied to a decoder, comprising:
determining a volume of a bounding box of a current node, and determining a number of points of the current node; and
when it is determined that the volume of the bounding box and the number of points of the current node meet a preset condition, reconstructing the current node to determine a reconstructed point cloud of the current node.

2. The method of claim 1, wherein the preset condition comprises that the number of points is less than or equal to the volume of the bounding box.

3. The method of claim 2, further comprising:
when it is determined that the volume of the bounding box and the number of points of the current node do not meet the preset condition, initializing the number of points of the current node to the volume of the bounding box.

4. The method of claim 1, wherein determining the volume of the bounding box of the current node comprises:
decoding a bitstream to determine identification information of a first type of syntax element for the current node; and
determining the volume of the bounding box of the current node according to the identification information of the first type of syntax element.

5. The method of claim 4, wherein the first type of syntax element comprises: identification information of a first syntax element, identification information of a second syntax element, and identification information of the third syntax element; and
wherein determining the volume of the bounding box of the current node according to the identification information of the first type of syntax element comprises:
determining a length of the bounding box according to the identification information of the first syntax element;
determining a width of the bounding box according to the identification information of the second syntax element;
determining a height of the bounding box according to the identification information of the third syntax element; and
determining the volume of the bounding box of the current node by calculating a product of the length, the width, and the height of the bounding box of the current node.

6. The method of claim 5, wherein the identification information of the first syntax element comprises identification information of at least two sub-syntax elements;
the identification information of the second syntax element comprises identification information of at least two sub-syntax elements; and
the identification information of the third syntax element comprises identification information of at least two sub-syntax elements.

7. The method of claim 6, wherein the identification information of the at least two sub-syntax elements comprises: identification information of a first sub-syntax element and identification information of a second sub-syntax element; and
wherein the identification information of the first sub-syntax element is used for indicating values of lower bits of a size of the bounding box, and the identification information of the second sub-syntax element is used for indicating values of higher bits of the size of the bounding box.

8. The method of claim 1, wherein determining the number of points of the current node comprises:
decoding a bitstream to determine identification information of a second type of syntax element for the current node; and
determining the number of points of the current node according to the identification information of the second type of syntax element.

9. The method of claim 8, wherein the identification information of the second type of syntax element comprises identification information of at least two sub-syntax elements.

10. The method of claim 9, wherein the identification information of the at least two sub-syntax elements comprises: identification information of a third sub-syntax element and identification information of a fourth sub-syntax element; and
wherein the identification information of the third sub-syntax element is used for indicating values of lower bits of the number of points, and the identification information of the fourth sub-syntax element is used for indicating values of higher bits of the number of points.

11. The method of claim 1, wherein the current node comprises at least one of: a current point cloud sequence, a current point cloud frame, a current point cloud tile, or a current point cloud slice.

12. The method of claim 1, further comprising:
when it is determined that the volume of the bounding box and the number of points of the current node meet the preset condition, decoding geometric information of the current node; and
wherein reconstructing the current node to determine the reconstructed point cloud of the current node comprises:
reconstructing the current node according to the geometric information, to determine the reconstructed point cloud of the current node.

13. The method of claim 1, further comprising:
when the volume of the bounding box and the number of points do not meet the preset condition, determining that there is an error in decoding the current node.

14. The method of claim 13, wherein when the volume of the bounding box and the number of points do not meet the preset condition, determining that there is the error in decoding the current node, comprises:
when the volume of the bounding box and the number of points do not meet the preset condition, determining that there is an error in decoding geometric information of the current node.

15. The method of claim 1, wherein the current node is a node in which duplicate points are removed.

16. The method of claim 15, further comprising:
decoding a bitstream to determine identification information of a third type of syntax element for the current node; and
determining that the current node is the node in which the duplicate points are removed according to the identification information of the third type of syntax element.

17. A method for encoding, applied to an encoder, comprising:
determining a volume of a bounding box of a current node, and determining a number of points of the current node; and
when it is determined that the volume of the bounding box and the number of points of the current node meet a preset condition, encoding the current node to determine encoding information, and signalling the encoding information in a bitstream.

18. The method of claim 17, wherein the preset condition comprises that the number of points is less than or equal to the volume of the bounding box.

19. The method of claim 18, further comprising:
when it is determined that the volume of the bounding box and the number of points of the current node do not meet the preset condition, initializing the number of points of the current node to the volume of the bounding box.

20. A bitstream, wherein the bitstream is generated by performing bit encoding on information to be encoded, wherein the information to be encoded comprises at least one of: identification information of a first-type syntax element for indicating a volume of a bounding box of a current node, identification information of a second type of syntax element for indicating a number of points of the current node, or identification information of a third type syntax element for indicating that the current node is a node in which duplicate points are removed.
